(19) United States
(12) Patent Application Publication
(10) Pub. No.: US 2014/0359313 A1
(43) Pub. Date: Dec. 4, 2014

(54) IMPLEMENTATION OF AN AIR TUBE BUTTON

(71) Applicant: INTERNATIONAL BUSINESS MACHINES CORPORATION, Armonk, NY (US)

(72) Inventors: Keith M. CAMPBELL, Cary, NC (US); William M. MEGARITY, Raleigh, NC (US); Luke D. REMIS, Raleigh, NC (US); Gregory D. SELLMAN, Morrisville, NC (US)

(21) Appl. No.: 13/909,025

(22) Filed: Jun. 3, 2013

(51) Int. Cl. G06F 1/32

(52) U.S. Cl. CPC G06F 1/3206
USPC 713/300; 702/45

(57) ABSTRACT

An approach is described for implementing an air tube button in a computing system. An associated apparatus may include an air tube having an aperture located on a panel of the computing system. The apparatus further may include an airflow sensor located in the air tube and a fan configured for facilitating airflow though the air tube. The airflow sensor may be an anemometer, an air pressure gauge, or a mass flow meter. The apparatus further may include a service processor subsystem connected to the airflow sensor. The service processor subsystem may be configured for implementing a virtual signal having a default logical high value. The service processor subsystem further may be configured for establishing a baseline value by determining average airflow detected by the airflow sensor over a unit of time and commencing sampling of the airflow sensor to obtain airflow values at uniform time intervals.

### BACKGROUND

The various embodiments of the invention described herein generally relate to computing system interfaces and more specifically to an air tube button implemented via an airflow sensor.

A computing system generally includes one or more panels having one or more buttons through which a user may interface with a planar board (i.e., a motherboard) in order to select a desired function. For instance, a front panel of a server may include buttons corresponding to respective functions. Typical functions may pertain to powering on hardware components or adjusting system settings. In addition to physical buttons, conventional button interfaces generally require membrane pads and ribbon cables to establish a connection to a planar board. Such conventional interfaces may be relatively expensive and prone to wear, particularly after an extended time period.

### BRIEF SUMMARY

The various embodiments of the invention described herein provide an air tube button interface without the physical attributes of a conventional button interface. One embodiment includes a method of implementing an air tube button via an airflow sensor in a computing system. The airflow sensor may be one of an anemometer, an air pressure gauge, and a mass flow meter. The method may include implementing, via a service processor subsystem of the computing system, a virtual signal having a default logical high value. The service processor system may include at least one of a microprocessor and a field-programmable gate array (FPGA). The method further may include establishing a baseline value by determining average airflow detected by the airflow sensor over a unit of time. The method further may include commencing sampling of the airflow sensor to obtain airflow values at uniform time intervals.

In one embodiment, the method further may include, upon determining that two consecutive airflow samples are less than a designated percentage of the baseline value, changing the value of the virtual signal from logical high to logical low, and driving out the virtual signal to activate at least one function within the computing system. The at least one function may include at least one of enabling one or more power control functions and providing a visual indication to a user of the computing system. Furthermore, the method may include, upon determining that two consecutive airflow samples are greater than or equal to the designated percentage of the baseline value, changing the value of the virtual signal back to logical high from logical low.

An additional embodiment includes a computer readable storage medium storing an application, which, when executed on a processor, performs an operation of implementing an air tube button via an airflow sensor. The steps of such operation may reflect the steps of the aforementioned method.

A further embodiment includes an air tube button apparatus in a computing system. The apparatus may include an air tube having an aperture located on a panel of the computing system. The apparatus further may include an airflow sensor located in the air tube. Additionally, in one embodiment, the apparatus may include a fan configured for facilitating airflow though the air tube. The apparatus further may include a service processor subsystem connected to the airflow sensor. The service processor subsystem may be configured for implementing a virtual signal having a default logical high value. The service processor subsystem further may be configured for establishing a baseline value by determining average airflow detected by the airflow sensor over a unit of time. The service processor subsystem further may be configured for commencing sampling of the airflow sensor to obtain airflow values at uniform time intervals.

In one embodiment, the service processor subsystem further may be configured for, upon determining that two consecutive airflow samples are less than a designated percentage of the baseline value, changing the value of the virtual signal from logical high to logical low, and driving out the virtual signal to activate at least one function within the computing system. The at least one function may include at least one of enabling one or more power control functions and providing a visual indication to a user of the computing system. The service processor subsystem further may be configured for, upon determining that two consecutive airflow samples are greater than or equal to the designated percentage of the baseline value, changing the value of the virtual signal back to logical high from logical low.

### BRIEF DESCRIPTION OF SEVERAL VIEWS OF THE DRAWINGS

So that the manner in which the above recited aspects are attained and can be understood in detail, a more particular description of embodiments, briefly summarized above, may be had by reference to the appended drawings.

Note, however, that the appended drawings illustrate only typical embodiments of this invention and are therefore not to be considered limiting of its scope, for the invention may admit to other equally effective embodiments.

FIG. 1 illustrates a planar board and an airflow sensor, according to one embodiment of the invention.

FIG. 2 illustrates a computing system with a plurality of air tube button interfaces and the planar board illustrated in FIG. 1, according to one embodiment of the invention.

FIG. 3 illustrates a method of implementing an air tube button, according to one embodiment of the invention.

### DETAILED DESCRIPTION

The various embodiments of the invention described herein are directed to techniques for implementing an air tube button via an airflow sensor. Such air tube button may be implemented on any type of computing system, including a rack server, a server blade, or a personal computing device.

According to an embodiment, an air tube button of a computing system may include a small air tube having an airflow sensor located therein. Airflow through the air tube may be facilitated by a system fan or a power supply fan. Such fan may draw air through the air tube and over the airflow sensor. The airflow sensor in the air tube may be connected to a service processor subsystem of a planar board. The airflow sensor may be any device capable of detecting changes in airflow, such as an anemometer, an air pressure gauge, or a mass flow meter. The service processor subsystem may include at least one of a microprocessor and a field-programmable gate array (FPGA). The airflow sensor may measure airflow, and the microprocessor or FPGA of the service processor subsystem may sample the measured airflow to determine a “button press” and a subsequent “button release”.

An interface of the air tube button, which may be located on a panel of the computing system, may include an aperture (i.e., opening) of the air tube. When a user of the computing system places an obstruction over the aperture (e.g., a finger or other object), the airflow sensor within the air tube may detect a resulting decrease in the airflow through the air tube. As further described herein, the service processor subsystem may process such decrease in airflow as a “button press” once airflow sampled at the airflow sensor decreases to a value less than a designated percentage of an established baseline value. Subsequently, when such user removes the obstruction over the aperture, the airflow sensor may detect a resulting increase in the airflow through the air tube. As further described herein, the service processor subsystem may process such increase in airflow to determine a “button release” once airflow sampled at the airflow sensor increases to a value greater than or equal to the designated percentage of the established baseline value.

More specifically, the service processor subsystem may implement a virtual signal. The microprocessor or FPGA of the service processor subsystem may implement the virtual signal via a software programming language or via a hardware description language. The default value of such virtual signal may be logical high (e.g., binary ‘1’). The service processor subsystem may establish a baseline value by determining average airflow detected by the airflow sensor over a unit of time (e.g., 1 s). Additionally, the service processor subsystem may commence sampling of the airflow sensor at uniform time intervals (e.g., every 100 ms) in order to determine change in airflow over time. Upon determining that two consecutive airflow samples are less than a designated percentage (e.g., 50%) of the baseline value, the service processor subsystem may determine that there has been a decrease in airflow significant enough to indicate a “button press”. Accordingly, the service processor subsystem may change the value of the virtual signal from logical high to logical low (e.g., binary ‘0’). Consequently, the service processor subsystem may drive out the virtual signal to activate at least one function within the computing system. Subsequent to a “button press”, upon determining that two consecutive airflow samples are equal to or greater than the designated percentage of the baseline value, the service processor subsystem may determine that there has been an increase in airflow significant enough to indicate a “button release”. Accordingly, the service processor subsystem may change the value of the virtual signal back to logical high from logical low. Subsequently, the service processor subsystem may establish a new baseline for additional sampling.

Accordingly, when a user of the computing system blocks the flow of air at the aperture of the air tube button interface, the airflow sensor may detect the resulting decrease in airflow in the air tube. Once the sampled airflow decreases below the designated percentage of the baseline value, the service processor subsystem consequently may change the virtual signal from logical high to logical low to implement a “button press”. When the user unblocks the flow of air at the aperture, the airflow sensor may detect the resulting increase in airflow in the air tube. Once the sampled airflow increases to at or above the designated percentage of the baseline value, the service processor subsystem consequently may change the virtual signal back to logical high from logical low to implement a “button release”.

The various embodiments of the invention described herein may have various advantages over a conventional button interface. An air tube button interface according to the various embodiments may overcome the shortcomings of a conventional physical button interface. While a conventional physical button interface requires multiple parts, such as a membrane pad and a ribbon cable in addition to a physical button, an air tube button may function by detecting airflow changes in an air tube via an airflow sensor. Accordingly, an air tube button interface according to an embodiment may be relatively less expensive and less prone to wear than a conventional physical button interface. Furthermore, since an air tube button interface according to an embodiment may include an aperture through which heat generated by the relevant computing system may flow, such air tube button interface may have thermal advantages over a conventional physical button interface.

In the following, reference is made to various embodiments of the invention. However, it should be understood that the invention is not limited to specific described embodiments. Instead, any combination of the following features and elements, whether related to different embodiments or not, is contemplated to implement and practice the invention. Furthermore, although embodiments may achieve advantages over other possible solutions and/or over the prior art, whether or not a particular advantage is achieved by a given embodiment is not limiting. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium or, alternatively, a computer readable signal medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++, or the like and conventional procedural programming languages such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions also may be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The various embodiments described herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g., an amount of storage space consumed by a user or a number of virtualized systems instantiated by the user). A user can access any of the resources that reside in the cloud at any time, and from anywhere across the Internet. In context of the various embodiments described herein, workloads of a computing system implementing an air tube button may be deployed to a computing cloud (whether the cloud itself is provided by the enterprise or a third party). Moreover, cloud-based database systems, virtual machines, and a variety of other server applications may be used to manage such workloads.

The flowchart and block diagrams in the Figures illustrate the architecture, functionality and operation of possible implementations of systems, methods and computer program products according to various embodiments of the present invention. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Further, particular embodiments describe techniques for implementing an air tube button via an airflow sensor. However, it should be understood that the techniques described herein may be adapted to a variety of purposes in addition to those specifically described herein. Accordingly, references to the specific embodiments are included to be illustrative and not limiting.

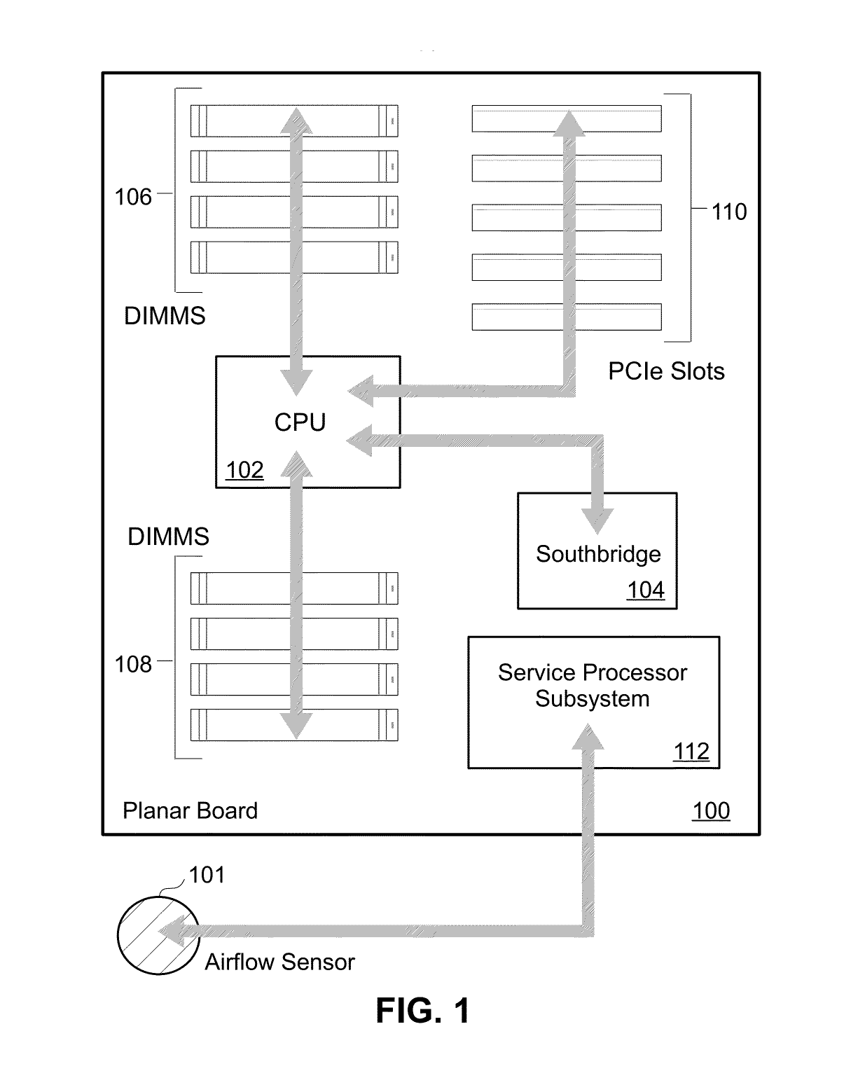

FIG. 1 illustrates a planar board (i.e., motherboard) 100 connected to an airflow sensor 101, according to an exemplary embodiment. As shown, planar board 100 may include a CPU 102. CPU 102 is included to be representative of a single CPU, multiple CPUs, a single CPU having multiple processing cores, and the like. CPU 102 may support multithreading. Planar board 100 also may include a southbridge 104 connected to CPU 102. Moreover, planar board 100 may include dual in-line memory module (DIMM) sets 106 and 108. Although two DIMM sets are depicted in FIG. 1, planar board 100 may include any number of DIMM sets that can be accommodated by planar board 100. Other memory modules may be included on planar board 100 in addition to or as an alternative to DIMM sets 106 and 108. Furthermore, planar board 100 may include peripheral component interconnect express (PCIe) slots 110 to facilitate connection of input/output (I/O) devices to planar board 100. For instance, one or more storage devices, network devices, or other peripheral devices may be connected to planar board 100 via PCIe slots 110. Although five PCIe slots are depicted in FIG. 1, planar board 100 may include any number of PCIe slots that can be accommodated by planar board 100.

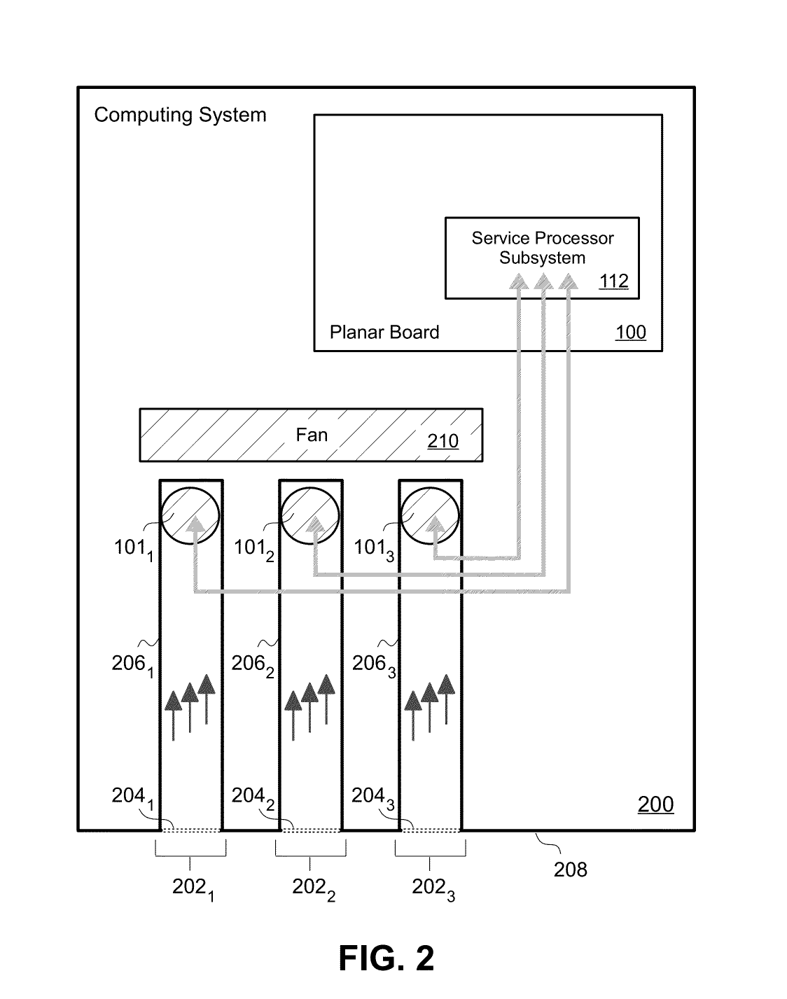

Furthermore, planar board 100 may include a service processor subsystem 112. Service processor subsystem 112 may include at least one of a microprocessor and a FPGA. Service processor subsystem 112 may be connected to airflow sensor 101. Airflow sensor 101 may be representative of a single airflow sensor or multiple airflow sensors (e.g., airflow sensors 101₁, 101₂, 101₃, as further described herein with respect to FIG. 2). The microprocessor or FPGA of the service processor subsystem may process data provided by airflow sensor 101.

FIG. 2 illustrates a computing system 200 including air tube button interfaces 202₁, 202₂, 202₃ and planar board 100, according to an exemplary embodiment. Although three button interfaces are depicted in FIG. 2, computing system 200 may include any number of button interfaces that can be accommodated by computing system 200. Button interfaces 202₁, 202₂, 202₃ respectively may include apertures 204₁, 204₂, 204₃ of air tubes 206₁, 206₂, 206₃. Button interfaces 202₁, 202₂, 202₃ with respective apertures 204₁, 204₂, 204₃ may be located on a panel 208 of computing system 200. While shown on the panel 208, button interfaces 202₁, 202₂, 202₃ with respective apertures 204₁, 204₂, 204₃ may be located on any panel of computing system 200. Air tubes 206₁, 206₂, 206₃ respectively may include airflow sensors 101₁, 101₂, 101₃. Airflow sensors 101₁, 101₂, 101₃ may be connected to the service processor subsystem 112 of planar board 100. A fan 210 may facilitate airflow through air tubes 206₁, 206₂, 206₃, as indicated by the arrows in each air tube. The fan 210 may draw air through air tubes 206₁, 206₂, 206₃ and over respective airflow sensors 101₁, 101₂, 101₃.

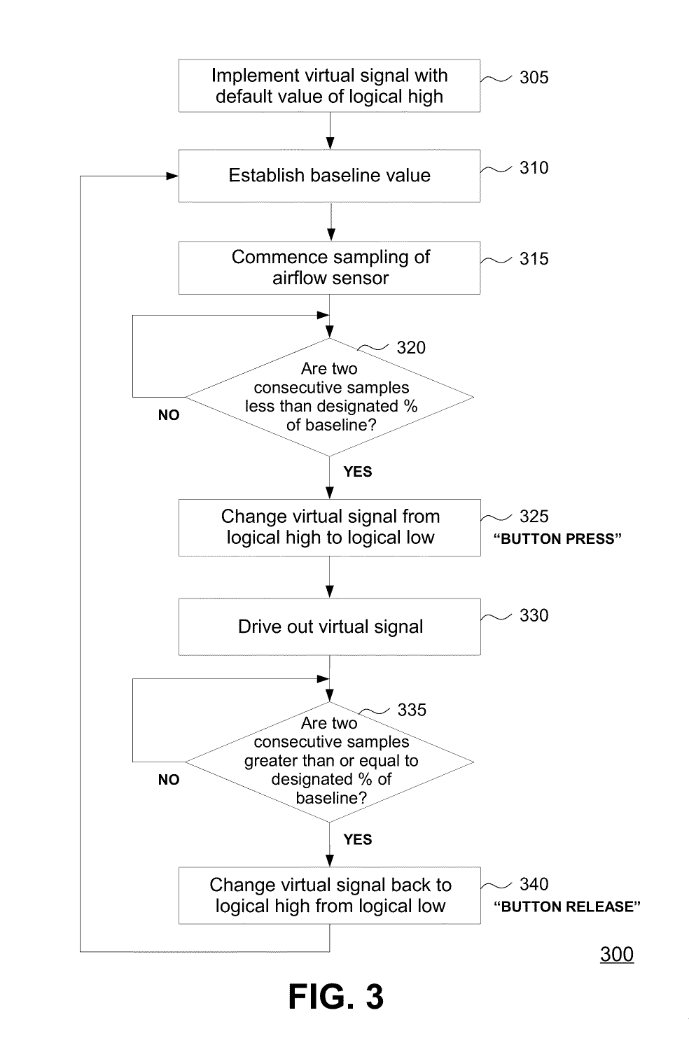

FIG. 3 illustrates a method 300 of implementing an air tube button via an airflow sensor (e.g., respective airflow sensors 101₁, 101₂, 101₃) and a service processor system on a planar board (e.g., service processor subsystem 112 on planar board 100) of a computing system (e.g., computing system 200), according to an exemplary embodiment. The method 300 may begin at step 305, where the service processor subsystem may implement a virtual signal. Specifically, the microprocessor or FPGA of the service processor subsystem may implement the virtual signal via a software programming language (e.g., C or C++) or via a hardware description language (e.g., VHDL). The default value of such virtual signal may be logical high (e.g., binary ‘1’). At step 310, the service processor subsystem may establish a baseline value by determining average airflow detected by the airflow sensor over a unit of time (e.g., 1 s). At step 315, the service processor subsystem may commence sampling of the airflow sensor to obtain airflow values at uniform time intervals (e.g., every 100 ms).

At step 320, the service processor subsystem may determine whether two consecutive airflow samples are less than a designated percentage (e.g., 50%) of the baseline value established at step 310. The service processor subsystem may seek two consecutive airflow samples in step 320 (rather than a single airflow sample) in order to filter out any airflow “noise” that occasionally may result in a single airflow sample being less than the designated percentage. Two consecutive airflow samples determined at step 320 to be less than the designated percentage of the baseline value may indicate that a user of the computing system has placed an obstruction over an aperture of the air tube in which the airflow sensor is located. Upon determining that two consecutive airflow samples are not less than the designated percentage of the baseline value, step 320 may be repeated. Upon determining that two consecutive airflow samples are less than the designated percentage of the baseline value, at step 325 the service processor subsystem may change the value of the virtual signal from logical high to logical low (e.g., binary ‘0’), thus indicating a “button press.” At step 330, the service processor subsystem may drive out the virtual signal to activate at least one function within the computing system. For instance, the service processor subsystem may enable one or more power control functions. As another example, the service processor subsystem may provide a visual indication to the user of the computer system indicating that the air tube button has been “pressed” (e.g., a light-emitting diode in the air tube may be switched on).

At step 335, the service processor subsystem may determine whether two consecutive airflow samples from the airflow sensor are greater than or equal to the designated percentage of the baseline value. Two consecutive airflow samples determined at step 335 to be greater than or equal to than the designated percentage of the baseline value may indicate that the user of the computing system has removed the obstruction over the aperture of the air tube in which the airflow sensor is located. Upon determining that two consecutive airflow samples from the airflow sensor are not greater than or equal to the designated percentage of the baseline value, step 335 may be repeated. Upon determining that two consecutive airflow samples are greater than or equal to the designated percentage of the baseline value, at step 340 the service processor subsystem may change the value of the virtual signal back to logical high from logical low, thus indicating a “button release”. Subsequently, the method 300 may return to step 310, and the service processor subsystem may establish a new baseline for additional sampling.

According to a further embodiment, an airflow sensor may detect temperature in the air tube in which it is located. A service processor subsystem may sample the airflow sensor to obtain temperature values as well as airflow values. A microprocessor or FPGA of the service processor subsystem may process the temperature values or airflow values to determine potential issues in the computing system. For instance, in the context of FIG. 2, airflow sensors 101₁, 101₂, 101₃ may detect temperature in respective air tubes 206₁, 206₂, 206₃ of the computing system 200 and may send temperature samples as well as airflow samples to the service processor subsystem 112. Using the temperature samples or airflow samples, the service processor subsystem 112 may detect failure of a system fan (e.g., fan 210) or an air tube blockage.

According to the various embodiments described herein, a relatively inexpensive and durable air tube button may be implemented. In addition to cost and durability advantages, such air tube button may provide thermal advantages over a conventional physical button. Such air tube button may be included in a wide range of computing systems. Furthermore, as a result of an included airflow sensor, such air tube button may facilitate detection of computing system issues. Additionally, such air tube button may provide a visual indication to a user once “pressed” (e.g., a light emitting diode may be switched on).

While the foregoing description is directed to various embodiments, such description is not intended to limit the scope of the invention. All kinds of modifications made to the described embodiments and equivalent arrangements should fall within the protected scope of the invention. Hence, the scope of the invention should be explained most widely according to the claims that follow in connection with the detailed description, and should cover all the possibly equivalent variations and equivalent arrangements. Accordingly, further embodiments may be devised without departing from the basic scope of the invention.

1. A method of implementing an air tube button via an airflow sensor, wherein the airflow sensor is located in an air tube having an aperture located on a panel of a computing system, the method comprising:
implementing, via a service processor subsystem of the computing system, a virtual signal having a default logical high value;
establishing a baseline value by determining average airflow detected by the airflow sensor over a unit of time;
commencing sampling of the airflow sensor to obtain airflow values at uniform time intervals; and
upon determining that two consecutive sampled airflow values are less than a designated percentage of the baseline value:
changing the value of the virtual signal from logical high to logical low, and
activating at least one function within the computing system.

2. (canceled)

3. The method of claim 1, further comprising:
upon determining that two consecutive sampled airflow values are greater than or equal to the designated percentage of the baseline value, changing the value of the virtual signal back to logical high from logical low.

4. The method of claim 1, wherein the airflow sensor is one of an anemometer, an air pressure gauge, and a mass flow meter.

5. The method of claim 1, wherein the service processor system includes at least one of a microprocessor and a field-programmable gate array (FPGA).

6. The method of claim 1, wherein the at least one function comprises at least one of enabling one or more power control functions and providing a visual indication to a user of the computing system.

7. A computer readable storage medium storing an application, which, when executed on a service processor subsystem of a computing system, performs an operation of implementing an air tube button via an airflow sensor, wherein the airflow sensor is located in an air tube having an aperture located on a panel of the computing system, the operation comprising:
implementing a virtual signal having a default logical high value;
establishing a baseline value by determining average airflow detected by the airflow sensor over a unit of time;
commencing sampling of the airflow sensor to obtain airflow values at uniform time intervals; and
upon determining that two consecutive sampled airflow values are less than a designated percentage of the baseline value:
changing the value of the virtual signal from logical high to logical low, and
activating at least one function within the computing system.

8. (canceled)

9. The computer readable storage medium of claim 7, wherein the operation further comprises:
upon determining that two consecutive sampled airflow values are greater than or equal to the designated percentage of the baseline value, changing the value of the virtual signal back to logical high from logical low.

10. The computer readable storage medium of claim 7, wherein the airflow sensor is one of an anemometer, an air pressure gauge, and a mass flow meter.

11. The computer readable storage medium of claim 7, wherein the service processor system includes at least one of a microprocessor and a FPGA.

12. The computer readable storage medium of claim 7, wherein the at least one function comprises at least one of enabling one or more power control functions and providing a visual indication to a user of the computing system.

13. An air tube button apparatus in a computing system, the apparatus comprising:
an air tube having an aperture located on a panel of the computing system;
an airflow sensor located in the air tube; and
a service processor subsystem connected to the airflow sensor, wherein the service processor subsystem is configured for:
implementing a virtual signal having a default logical high value;
establishing a baseline value by determining average airflow detected by the airflow sensor over a unit of time;
commencing sampling of the airflow sensor to obtain airflow values at uniform time intervals; and
upon determining that two consecutive sampled airflow values are less than a designated percentage of the baseline value:
changing the value of the virtual signal from logical high to logical low, and
activating at least one function within the computing system.

14. The air tube button apparatus of claim 13, further comprising:
a fan configured for facilitating airflow through the air tube.

15. (canceled)

16. The air tube button apparatus of claim 13, the service processor subsystem is further configured for, upon determining that two consecutive sampled airflow values are greater than or equal to the designated percentage of the baseline value, changing the value of the virtual signal back to logical high from logical low.

17. The air tube button apparatus of claim 13, wherein the airflow sensor is one of an anemometer, an air pressure gauge, and a mass flow meter.

18. The air tube button apparatus of claim 13, wherein the service processor system includes at least one of a microprocessor and a FPGA.

19. The air tube button apparatus of claim 13, wherein the at least one function comprises at least one of enabling one or more power control functions and providing a visual indication to a user of the computing system.

20. The method of claim 1, further comprising processing sampled airflow values or sampled air tube temperature values detected via the airflow sensor to determine at least one of (i) failure of a fan of the computing system and (ii) blockage of the air tube.

21. The computer readable storage medium of claim 7, wherein the operation further comprises processing sampled airflow values or sampled air tube temperature values detected via the airflow sensor to determine at least one of (i) failure of a fan of the computing system and (ii) blockage of the air tube.

22. The air tube button apparatus of claim 13, wherein the service processor subsystem is further configured for processing sampled airflow values or sampled air tube temperature values detected via the airflow sensor to determine at least one of (i) failure of a fan of the computing system and (ii) blockage of the air tube.
